(19) United States
(12) Patent Application Publication
(10) Pub. No.: US 2024/0404025 A1
(43) Pub. Date: Dec. 5, 2024

(54) METHOD FOR IMAGE MOTION DEBLURRING, APPARATUS, ELECTRONIC DEVICE AND MEDIUM THEREFOR

(71) Applicant: NANJING UNIVERSITY OF POSTS AND TELECOMMUNICATIONS, Nanjing (CN)

(72) Inventors: Dengyin ZHANG, Nanjing (CN); Yifei BAO, Nanjing (CN); Junhao YING, Nanjing (CN); Can CHEN, Nanjing (CN); Chao ZHOU, Nanjing (CN)

(21) Appl. No.: 18/675,032

(22) Filed: May 27, 2024

(30) Foreign Application Priority Data
Jun. 2, 2023 (CN) 202310649823.6

(51) Int. Cl. G06T 5/73; G06T 3/40; G06T 5/60

(52) U.S. Cl. CPC G06T 5/73; G06T 3/40; G06T 5/60; G06T 2207/20016; G06T 2207/20081; G06T 2207/20084; G06T 2207/20201

(57) ABSTRACT

A method for image motion deblurring, an apparatus, an electronic device and medium therefor are provided. The method includes obtaining a motion-blurred image to be deblurred; inputting the obtained blurred image into a pre-constructed and pre-trained image motion deblur model based on a multi-scale feature fusion module and a local channel information interaction module to obtain a clear image; wherein, the image motion deblur model is obtained through extracting characteristic information of different spatial scales and frequencies through the multi-scale feature fusion module for feature fusion, and exchanging local channel information of the fused feature map with local channel information in an one-dimensional convolution manner through the local channel information interaction module, and then training a dataset with a objective of minimizing a loss function based on adversarial loss and content loss. It can effectively eliminate artifacts and restore texture details, further improving the clarity of images.

### CROSS-REFERENCE TO RELATED APPLICATIONS

This application further claims to the benefit of priority from Chinese Application No. 202310649823.6 with a filing date of Jun. 2, 2023, the content of the aforementioned applications, including any intervening amendments thereto, are incorporated herein by reference.

### TECHNICAL FIELD

The present disclosure relates to the technical field of image processing, specifically to a method for image motion deblurring, an apparatus, an electronic device and medium therefor.

### BACKGROUND

Nowadays, the explosive growth in information volume caused by the Internet of Things era has put forward higher requirements for information processing technology, especially for image processing technology that needs continuous innovation and improvement to meet more new practical needs. Image motion deblurring, as a key technology in the field of image processing, aims to remove the image blur caused by objects moving relative to the shooting lens in the scene during scene shooting exposure. Motion blur not only affects image quality, but also brings inconvenience to some image-based application scenarios. For example, when capturing vehicles moving at high speeds on the street through road monitoring, blurring often occurs, making it difficult to accurately identify some detailed features of the vehicles, which brings difficulties in substantiate some irregularities and violations. In target detection scenes, such as on-board camera, intelligent traffic monitoring, intelligent security system of autonomous vehicle, etc., image motion blur often reduces the accuracy of target recognition.

The current image motion deblurring algorithms can be roughly divided into two types: non-blind motion deblurring algorithms and blind motion deblurring algorithms. The main difference lies in whether the specific parameters of the blur kernel are known in advance. The non-blind motion deblurring algorithm requires the specific information and parameters of the blur kernel to be determined in advance, and then the clear image can be reconstructed through deconvolution. Common methods include LR algorithm, Wiener filtering, and regularization based methods. However, non-blind motion deblurring algorithms require prior knowledge of the degradation function of the blurred image, which is often not feasible in practical application. Therefore, in the case of unknown degradation functions, it is necessary to use blind motion deblurring methods. The blind motion deblurring algorithm does not require clear knowledge of the blur kernel information and is usually an end-to-end model, which directly outputs the blurred image of the input end-to-end model as a clear image. Its main advantage is that it can better adapt to various types of blur. Wherein, the blind motion deblurring algorithm based on deep learning can more efficiently restore clear images from blurred images, mainly divided into three categories: convolutional neural network-based, recurrent neural network-based, and generative adversarial network-based.

Specifically, the method based on CNN (Convolutional Neural Network) have advantages such as efficiency, accuracy, and flexibility in image motion deblurring tasks. CNN has the characteristic of local weight sharing, which leads to higher efficiency in image processing. However, this method has the drawbacks of a large number of network parameters, slow fitting, and high training difficulty. The method based on RNN network (recurrent neural network) can transfer the input information and past state information of each time step to the next time step in the image motion deblurring task. During the image processing, the accumulated feature information can be fused. Compared to CNN, it has better deblurring effect and smaller parameter size, but the RNN model network structure is still complex. The image motion deblurring method based on generative adversarial networks aims to generate high-quality samples by having a generator and a discriminator confront each other. As the current mainstream deblurring algorithm, this type of method is represented by the DeblurGAN method based on conditional generative adversarial networks. This method can achieve superior performance in subjective vision, structural similarity indicators, and image processing speed. However, this method makes the generation results dependent on the selection of the dataset, making network training difficult. In addition, in actual performance, all three methods mentioned above will encounter problems such as inability to eliminate artifacts and ineffective restoration of texture details.

### SUMMARY

The objective of the present disclosure is to overcome the shortcomings of prior art, and provides a method for image motion deblurring, an apparatus, an electronic device, and medium therefor to solve the technical problems of the inability to eliminate artifacts and poor texture detail restoration effect in the motion deblurring methods of prior art.

To solve the above technical problems, the present disclosure is achieved using the following technical solutions:
The first aspect, a method for image motion deblurring is provided, including:
Obtaining a motion-blurred image to be deblurred;
Inputting the obtained blurred image into a pre-constructed and pre-trained image motion deblur model based on a multi-scale feature fusion module and a local channel information interaction module to obtain a clear image;
Wherein, the image motion deblur model is obtained through extracting characteristic information of different spatial scales and frequencies through the multi-scale feature fusion module for feature fusion, and exchanging a fused feature map with local channel information in an one-dimensional convolution manner through the local channel information interaction module, and then training a dataset with a objective of minimizing a loss function based on adversarial loss and content loss.

Preferably, based on the first aspect, the constructed image motion deblur model includes: a convolutional layer for preliminary feature extraction, a plurality of residual blocks with the same structure, and a convolutional layer for image reconstruction; the residual block includes the multi-scale feature fusion module and the local channel information interaction module; the multi-scale feature fusion module includes a pyramid convolutional layer and a channel attention mechanism layer; and the local channel information interaction module includes a global average pooling layer and an one-dimensional convolutional layer.

Preferably, based on the first aspect, the step of extracting characteristic information of different spatial scales and frequencies through the multi-scale feature fusion module for feature fusion includes:
Obtaining an initial feature map X;
Conducting feature extraction on the obtained initial feature map X under different spatial scales and frequencies by using multiple types of convolutional kernels in the pyramid convolutional layer to obtain a plurality of sub-feature maps, which are expressed as:

$${F}_{i} = Conv ( {k}_{i} \times {k}_{i} , {G}_{i} ) ( X )$$

In the formula, Fᵢ∈R^{C′×H×w} represents the i-th sub-feature map obtained from the initial feature map X after passing through the i-th type of convolution kernel, i=0, 1, 2, - - - , S−1; S represents the type of convolution kernel; R represents the feature domain, C′, H, and W respectively represent the number of channels, height, and width of the sub-feature maps, Conv represents the convolution operation; kᵢ×kᵢ represents the size of the i-th kernel; Gᵢ represents the calculation parameter for the number of channels in the i-th type of convolutional kernel, which is expressed as follows:

$${G}_{i} = \{ \begin{matrix}{2}^{\frac{{k}_{i} - 1}{2}} , & {k}_{i} > 3 \\ 1 , & {k}_{i} = 3\end{matrix} ;$$

Using the channel attention mechanism layer to obtain channel attention weights of each sub-feature map, and using the Softmax normalization function to calibrate the channel attention weights of each sub-feature map, and the expression is:

$${Z}_{i} = SE ( {F}_{i} )$$

$${att}_{i} = Softmax ( {Z}_{i} ) = \frac{exp ( {Z}_{i} )}{{\sum }_{i = 0}^{S - 1} exp ( {Z}_{i} )}$$

In the formula, Zᵢ∈R^{C′×1×1} is the channel attention weight of the i-th sub-feature map, SE represents the channel attention mechanism; attᵢ represents the normalized channel attention weight of the i-th sub feature map;
Multiplying each sub-feature map with its corresponding normalized channel attention weight, and concatenating the multiplied feature maps using concatenation operation to obtain the fused feature map, which is expressed as:

$${Y}_{i} = {F}_{i} ⊙ {att}_{i}$$

$${X}^{′} = Cat ( [ {Y}_{0} , {Y}_{1} , {Y}_{2} , … , {Y}_{S - 1} ] )$$

In the formula, Yᵢ represents the i-th sub-feature map with channel attention weights, ⊙ represents multiplication of channels; ×′ represents the fused feature map, and Cat represents concatenation operation.

Preferably, based on the first aspect, the step of exchanging the fused feature map with local channel information in the one-dimensional convolution manner includes:
Obtaining the fused feature map output by the multi-scale feature fusion module;
Using the global average pooling layer to perform a global average pooling (GAP) operation on the fused feature map, and the expression is:

$$y = g ( {X}^{′} ) = \frac{1}{WH} {\sum }_{m = 1 , n = 1}^{W , H} {X}_{mn}^{′}$$

In the formula, g(X′) represents the global average pooling of the fused feature map, W, H respectively represents the width and the height of the fused feature map X′, X′ₘₙ represents the pixel values in the m-th row and the n-th column of the fused feature map X′, and y represents the output;
The output y after global average pooled is interacted with the local channel information through the one-dimensional convolutional layer, which is expressed as:

ω=σ(Conv1Dₖ(y))
In the formula, ω represents the channel attention weight after interaction, Conv1Dₖ represents the one-dimensional convolution kernel, k is the size of the convolution kernel, and σ represents the Sigmod activation function;
Multiplying the channel attention weight ω with the fused feature map X′ to assign channel attention to the fused feature map X′ to obtain an information interaction feature map X″.

Preferably, based on the first aspect, the output of the residual block after processing the obtained initial feature map X is the result of adding the initial feature map X and the information interaction feature map X″; the convolutional layer for image reconstruction includes three convolutional layers, and the output of the residual block after processed by the three convolutional layers is added to the obtained blurred image to obtain the final output clear image.

Preferably, based on the first aspect, the training method of the image motion deblur model includes:
Compressing the collected images in the dataset into images with a resolution of 360×360 and randomly cropping the image to the size of 256×256, then dividing them into a training set and a testing set;
Inputting the training set into the constructed image motion deblur model for multi-scale feature fusion and local channel information interaction to restore from the blur image;
Conducting a supervised training on the model according to the testing set using a loss function based on adversarial loss and content loss;
Repeating the training process to update the network parameters of the optimized model until the loss function converges or reaches the preset number of training iterations, and stop training to obtain the final optimized image motion deblur model.

Preferably, based on the first aspect, the loss function based on the adversarial loss and the content loss is as follows:

$${ℒ}_{total} = {ℒ}_{adv} + λ {ℒ}_{content}$$

In the formula, [symbol] ₜₒₜₐₗ represents the loss function, [symbol] _{adv} represents the adversarial loss, [symbol] _{content} represents the content loss, λ is a content loss coefficient; the adversarial loss [symbol] _{ad} is expressed as WGAN-GP as below:

$${ℒ}_{adv} = {𝔼}_{\tilde{x} ∼ {P}_{g}} [ D ( \tilde{x} ) ] - {𝔼}_{x ∼ {P}_{r}} [ D ( x ) ] + λ {𝔼}_{\hat{x} ∼ {P}_{\hat{x}}} [ {( {‖ {∇}_{\hat{x}} D ( \hat{x} ) ‖}_{2} - 1 )}^{2} ]$$

In the formula, D represents discriminator, x represents clear image, \tilde{x} represents network output image, \hat{x} represents random image, \hat{x}=∈\tilde{x}+(1−∈)x, ∈˜U[0,1]; P_{\hat{x}} represents that a distribution of image samples uniformly sampled along a straight line between a pair of points U[0,1] sampled from clear image distribution Pᵣ and network output image distribution P_{g};
The content loss adopts perceptual loss, which is expressed as:

$${ℒ}_{content} = \sum {‖ ϕ ( x ) - ϕ ( \tilde{x} ) ‖}_{2}^{2}$$

In the formula, ϕ represents the pre-trained VGG19 network.

The second aspect, an apparatus for image motion deblurring is provided, including:
An acquisition module, used to obtain a motion-blurred image to be deblurred;
An image motion deblur model, used to input the obtained blurred image into a pre-constructed and pre-trained image motion deblur model based on a multi-scale feature fusion module and a local channel information interaction module, so as to obtain a clear image;
Wherein, the image motion deblur model is obtained by extracting characteristic information of different spatial scales and frequencies through a multi-scale feature fusion module for feature fusion, and exchanging a fused feature map with local channel information in an one-dimensional convolution manner through the local channel information interaction module, and then training a dataset with a objective of minimizing a loss function based on adversarial loss and content loss.

The third aspect, an electronic device is provided, including a processor and a storage medium;
the storage medium is configured to store instructions;
the processor is configured to operate based on the instructions to execute the steps of the method for image motion deblurring as described in the first aspect.

The fourth aspect, a computer-readable storage medium that stores a computer program is provided. When the computer program is executed by a processor, the steps of the method for image motion deblurring as described in the first aspect are implemented.

Compared with existing technology, the advantageous effects achieved by the present disclosure are shown as below:

The image motion deblur model based on the multi-scale feature fusion module and the local channel information interaction module provided by the present disclosure has the characteristics of small network parameter quantity, fast fitting, and low training difficulty. It utilizes convolutional kernels of different scales and depths in the multi-scale feature fusion module to extract low-frequency information such as color brightness and high-frequency information such as texture details from images on the basis of different receptive fields, and these image features of different scales are lossless fused, and then the local channel information interaction module is used to interact and supplement information between each subfeatures, improving the learning ability of the network. This is conducive to the elimination of blurred image artifacts and the restoration of texture details, further improving the clarity of the image, and has great application value in application scenarios based on computer vision such as object detection.

### BRIEF DESCRIPTION OF THE DRAWINGS

FIG. 1 is a flowchart of the method for image motion deblurring provided in an embodiment of the present disclosure;

FIG. 2 is a schematic diagram of the network structure of the image motion deblur model provided in an embodiment of the present disclosure;

FIG. 3 is a schematic diagram of the network structure of the multi-scale feature fusion module provided in an embodiment of the present disclosure;

FIG. 4 is a schematic diagram of the network structure of the local channel information interaction module provided in an embodiment of the present disclosure;

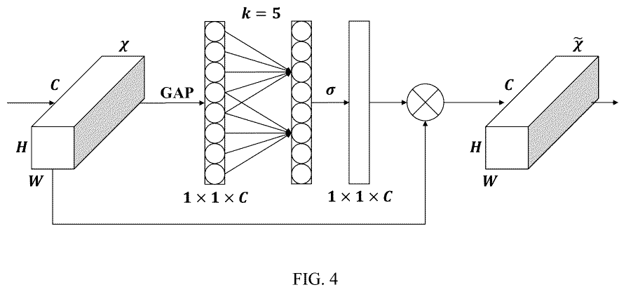

FIG. 5 shows comparison of the effects of the method provided in the embodiment of the present disclosure with the DeblurGAN method on processing blurred images;

FIG. 6 is a schematic diagram of the structure and principle of an apparatus for image motion deblurring provided in an embodiment of the present disclosure.

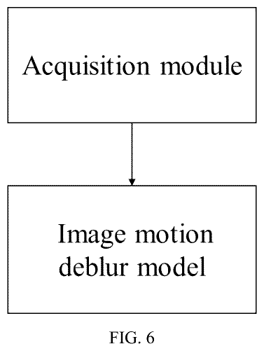

### DETAILED DESCRIPTION OF THE EMBODIMENTS

The following provides a detailed illustration of the technical solution of the present disclosure through the accompanying drawings and embodiments. It should be understood that the embodiments and specific features in the embodiments are a detailed description of the technical solution of the present disclosure, rather than a limitation on the technical solution of the present disclosure. Without conflict, the technical features in the embodiments of the present disclosure and the embodiments can be combined with each other.

The term “and/or” in this disclosure is only a description of the association relationship between related objects, indicating that there can be three types of relationships, for example, A and/or B, which can indicate the presence of A alone, the presence of A and B simultaneously, and the presence of B alone. In addition, the character “/” in this article generally indicates that the associated objects are an “or” relationship.

### Embodiment 1

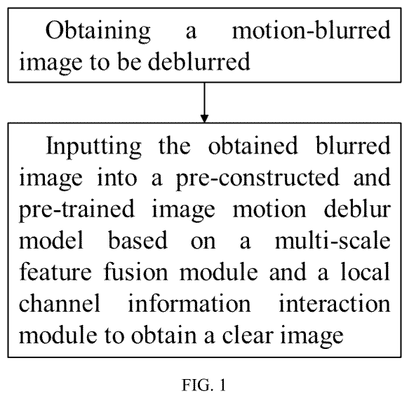

As shown in FIG. 1, a method for motion blur image removal is provided in the present embodiment, which includes the specific steps as following:
Step 1, obtaining a motion-blurred image to be deblurred;
Step 2, inputting the obtained blurred image into a pre-constructed and pre-trained image motion deblur model based on a multi-scale feature fusion module and a local channel information interaction module to obtain a clear image.

As an embodiment of the present disclosure, the image motion deblur model in Step 2 is obtained through extracting characteristic information of different spatial scales and frequencies through the multi-scale feature fusion module for feature fusion, and exchanging a fused feature map with local channel information in an one-dimensional convolution manner through the local channel information interaction module, and then training a dataset with a objective of minimizing a loss function based on adversarial loss and content loss.

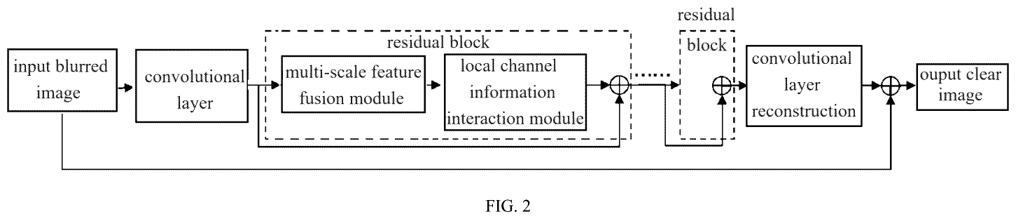

Specifically, as show in FIG. 2, the constructed image motion deblur model includes: a convolutional layer for preliminary feature extraction, a plurality of residual blocks with the same structure (preferably, the number of the residual blocks in the present embodiment is 9), and a convolutional layer for image reconstruction. Each residual blocks includes the multi-scale feature fusion module and the local channel information interaction module. Wherein, the preliminary feature extraction convolutional layer takes blurred images as input, and the preliminary extracted blurred image feature map is used as input for the residual block. The feature map input into the residual block first enters the multi-scale feature fusion module. The multi-scale feature fusion module contains a plurality of convolutional kernels of different scales and channels to extract feature information of different scales and frequencies. Then, different feature attention weights are assigned through channel attention mechanisms. Finally, feature fusion is performed through concatenation operation, and the output fusion feature map is used as the input of the local channel information interaction module. In the local channel information interaction module, efficient channel information interaction is achieved by sequentially passing through a global average pooling layer and an one-dimensional convolutional layer. The fusion feature map obtained through feature extraction and fusion of multiple residual blocks is reconstructed through the image reconstruction convolutional layer to finally output the reconstructed deblurred image.

Furthermore, the convolutional layer used for preliminary feature extraction performs preliminary feature extraction on the input blurred image. The feature extraction part consists of three layers of convolutional layers, each of which includes a convolutional kernel, an InstanceNorm layer, and a ReLU activation function. The size of the convolutional kernels in each layer is 7×7, 3×3, and 3×3, respectively.

As an embodiment of the present disclosure, the network structure of the multi-scale feature fusion module is shown in FIG. 2, including a pyramid convolution layer and a channel attention mechanism layer. The feature extraction part of the module is a pyramid convolution layer, and the pyramid convolution part includes S (wherein, the values of S are 3 to 6, and the preferred embodiment of the present disclosure is 4) convolution kernels, the size of i-th type kernel is kᵢ×kᵢ, and the calculation method is as follows:

$${k}_{i} = 2 i + 3 , i = 0 , 1 , 2 , … , S - 1$$

The calculation method for the number C₁ of channels in the i-th type of kernel is:

$${C}_{i} = \frac{C}{{G}_{i}} , i = 0 , 1 , 2 , … , S - 1$$

Wherein, Gᵢ is the calculation parameter for the number of channels in the i-th convolutional kernel, which is calculated as follows:

$${G}_{i} = \{ \begin{matrix}{2}^{\frac{{k}_{i} - 1}{2}} , & {k}_{i} > 3 \\ 1 , & {k}_{i} = 3\end{matrix} , i = 0 , 1 , 2 , … , S - 1.$$

As an embodiment of the present disclosure, the step of extracting characteristic information of different spatial scales and frequencies through the multi-scale feature fusion module for feature fusion in the Step 2 includes:
Step a: obtaining an initial feature map X;
Step b: conducting feature extraction on the obtained initial feature map X under different spatial scales and frequencies by using multiple types of convolutional kernels in the pyramid convolutional layer to obtain a plurality of sub-feature maps, which is expressed as:

$${F}_{i} = Conv ( {k}_{i} \times {k}_{i} , {G}_{i} ) ( X )$$

In the formula, Fᵢ∈R^{C′×H×w} represents the i-th sub-feature map obtained from the initial feature map X after passing through the i-th type of convolution kernel, i=0, 1, 2, - - - , S−1; S represents the type of convolution kernel; R represents the feature domain, C′, H, and W respectively represent the number of channels, height, and width of the sub-feature maps. It should be noted that through this method, multiple convolution kernels of different scales can process the original input feature map in parallel, independently learning spatial information of different scales and high and low frequency information.
Step c: using the channel attention mechanism layer to obtain channel attention weights of each sub-feature map, and using the Softmax normalization function to calibrate the channel attention weights of each sub-feature map, and the expression is:

$${Z}_{i} = SE ( {F}_{i} )$$

$${att}_{i} = Softmax ( {Z}_{i} ) = \frac{exp ( {Z}_{i} )}{{\sum }_{i = 0}^{S - 1} exp ( {Z}_{i} )}$$

In the formula, Zᵢ∈R^{C′×1×1} is the channel attention weight of the i-th sub-feature map, SE represents the channel attention mechanism; attᵢ represents the normalized channel attention weight of the i-th sub feature map;
It should be noted that the purpose of using the Softmax normalization function for calibration in this embodiment is to make the distribution of channel attention weights more stable, help the model focus more accurately on important regions, so as to improve the performance of the model. During this process, the channel attention weights Zᵢ are remapped into new probability values P(Zᵢ) through the Softmax function, i.e. attᵢ, which satisfies P(Zᵢ)∈(0,1), ΣP(Zᵢ)=1. Through such calibration, smaller weights can be effectively suppressed, making the model more focused on important channel features.
Step d: multiplying each sub-feature map with its corresponding normalized channel attention weight, and concatenating the multiplied feature maps using concatenation operation to obtain the fused feature map, which is expressed as:

$${Y}_{i} = {F}_{i} ⊙ {att}_{i}$$

$${X}^{′} = Cat ( [ {Y}_{0} , {Y}_{1} , {Y}_{2} , … , {Y}_{S - 1} ] )$$

In the formula, Yᵢ represents the i-th sub-feature map with channel attention weights, ⊙ represents multiplication of channels; X′ represents the fused feature map, and Cat represents the Concatenation operation.

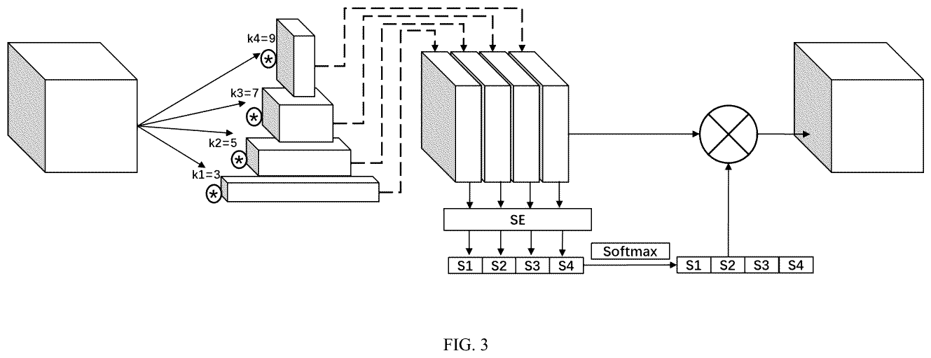

Furthermore, the fused feature map X′ obtained through the multi-scale feature fusion module is input into the local channel information interaction module. The number of channels of the fused feature map X′ is C, and the network structure of the local channel information interaction module is shown in FIG. 3. This module consists of a global average pooling layer and an one-dimensional convolutional layer.

As an embodiment of the present disclosure, the step of exchanging the fused feature map with local channel information in the one-dimensional convolution manner in the Step 2 includes:
Step A: obtaining the fused feature map output by the multi-scale feature fusion module;
Step B: using the global average pooling layer to perform a global average pooling (GAP) operation on the fused feature map, and the expression is:

$$y = g ( {X}^{′} ) = \frac{1}{WH} {\sum }_{m = 1 , n = 1}^{W , H} {X}_{mn}^{′}$$

In the formula, g(X′) represents the global average pooling of the fused feature map, W, H respectively represents the width and the height of the fused feature map X′, X′ₘₙ represents the pixel values in the m-th row and the n-th column of the fused feature map X′, and y represents the output. Wherein, the global average pooling operation converts the input of H×W×C into an output of 1×1×C, which compresses the two-dimensional features corresponding to each channel into a real number. The real number represents the global distribution on its corresponding feature channels.
Step C: the output y after global average pooled is interacted with the local channel information through the one-dimensional convolutional layer, which is expressed as:

ω=σ(Conv1Dₖ(y))
In the formula, ω represents the channel attention weight after interaction, Conv1Dₖ represents the one-dimensional convolution kernel, k is the size of the convolution kernel, and a represents the Sigmod activation function;
Step D: multiplying the channel attention weight ω with the fused feature map X′ to assign channel attention to the fused feature map X′ to obtain an information interaction feature map X″.

Further, the output of the residual block after processing the obtained initial feature map X is the result of adding the initial feature map X and the information interaction feature map X″. 9 residual blocks are set in the embodiment of the present disclosure, which require repeating the above residual block operation process 9 times on the feature map. After then, the feature maps extracted through these 9 residual blocks will be input into the convolutional layer used for image reconstruction to reconstruct a clear image. Wherein, the convolutional layer for image reconstruction includes three convolutional layers, and each layer includes convolutional kernel, InstanceNorm layer, and ReLU activation function, and the sizes of the convolutional kernels in each layer are 7×7, 3×3, and 3×3, respectively. By adding the output of these three convolutional layers to the original blurred image, a clear image output by the model is obtained.

As an embodiment of the present disclosure, in the Step 2, the training method of the image motion deblur model includes:
Step 1, compressing the collected images in the dataset into images with a resolution of 360×360 and randomly cropping the image to the size of 256×256, then dividing them into a training set and a testing set;
Wherein, this embodiment selects 1000 pairs of images from the GoPro dataset as the training set and 100 pairs of images as the testing set;
Step 2, inputting the training set into the constructed image motion deblur model for multi-scale feature fusion and local channel information interaction to obtain the deblurred reconstructed image of the model;
Step 3, conducting a supervised training on the model according to the testing set using a loss function based on adversarial loss and content loss;
Step 4, repeating the training process to update the network parameters of the optimized model until the loss function converges or reaches the preset number of training iterations, and stop training to obtain the final optimized image motion deblur model.

Furthermore, during the training process of the embodiments of the present disclosure, an Adam optimizer is used, with default parameters of beta1=0.9 and beta2=0.999; the initial learning rate is set to 10-4. After 300 cycles of iterative training, the learning rate remains unchanged at 10-4 for the first 150 cycles, and then linearly decays to 0 for the remaining 150 cycles; and training selection batch size batchsize=4.

Specifically, the loss function based on the adversarial loss and the content loss is as follows:

$${ℒ}_{total} = {ℒ}_{adv} + {λℒ}_{content}$$

In the formula, [symbol] ₜₒₜₐₗ represents the loss function, [symbol] _{adv} represents the adversarial loss, [symbol] _{content} represents the content loss, λ is a content loss coefficient (in the present embodiment, the value of λ is 100); the adversarial loss [symbol] _{adv} is used WGAN-GP, which is expressed as below:

$${ℒ}_{adv} = {𝔼}_{\tilde{x} ∼ {P}_{g}} [ D ( \tilde{x} ) ] - {𝔼}_{x ∼ {P}_{r}} [ D ( x ) ] + λ {𝔼}_{\hat{x} ∼ {P}_{\hat{x}}} [ {( {‖ {∇}_{\hat{x}} D ( \hat{x} ) ‖}_{2} - 1 )}^{2} ]$$

In the formula, D represents discriminator (The present embodiment adopts a Markov discriminator), x represents clear image, \tilde{x} represents network output image, \hat{x} represents random image, \hat{x}=∈\tilde{x}+(1−∈)x, ∈˜U[0,1]; P_{\hat{x}} represents that a distribution of image samples uniformly sampled along a straight line between a pair of points U[0,1] sampled from clear image distribution Pᵣ and network output image distribution P_{g}.

The content loss adopts perceptual loss is expressed as:

$${ℒ}_{content} = \sum {‖ ϕ ( x ) - ϕ ( \tilde{x} ) ‖}_{2}^{2}$$

In the formula, ϕ represents the pre-trained VGG19 network.

To verify the effectiveness of the model constructed in this embodiment, peak signal-to-noise ratio, structural similarity index measure, and recognition accuracy are selected as evaluation indicators.

The calculation formula for peak signal-to-noise ratio (PSNR) is:

$$PSNR ( p , q ) = 10 {log}_{10} [ \frac{{( {2}^{t} - 1 )}^{2}}{MSE ( p , q )} ]$$

In the formula: p, q represents two images respectively, t represents the bit number of pixels in the image, and MSE (Mean Square Error, MSE) represents the mean square error of the corresponding pixels in the two images with size M×N. The calculation formula is:

$$MSE ( x , y ) = \frac{1}{MN} {\sum }_{m = 1}^{M} {\sum }_{n = 1}^{N} {( {p}_{mn} - {q}_{mn} )}^{2}$$

In the formula, pₘₙ, qₘₙ represent the values of the pixel points of the image p and the image q in the m-th row and the n-th column, respectively.

The formula for calculating the structure similarity index measure (SSIM) is:

$$SSIM ( p , q ) = \frac{( 2 {µ}_{p} {µ}_{q} + {C}_{1} ) ( 2 {σ}_{pq} + {C}_{2} )}{( {µ}_{p}^{2} + {µ}_{q}^{2} + {C}_{1} ) ( {σ}_{p}^{2} + {σ}_{q}^{2} + {C}_{2} )}$$

In the formula, μₚ, μ_{q} represent the average pixel value of the image p and the average pixel value of the image q, respectively; σₚ, σ_{q} represent the variance of the image p and the variance of the image q, σ_{pq} represents the covariance of the pixels of the image p and the pixels of the image q, C1=(K₁×L)², C2=(K₂×L)², which are two constants, and L is the range of pixel values. The embodiments of the present disclosure take L=255, K₁=0.01, K₂=0.03.

The validation experiment will use the YOLOv5 object detection model to further evaluate the quality of the motion deblurring algorithm from the perspective of recognition accuracy. The calculation formula for recognition accuracy (Accuracy) is as follows:

$$Accuracy = \frac{the number of identified correct samples}{the number of all samples}$$

Table 1 shows the comparison between the present disclosure method and the mainstream image motion deblurring algorithm DeblurGAN in terms of the peak signal-to-noise ratio (PSNR) and the structure similarity index measure (SSIM):

TABLE 1
Comparison of PSNR&SSIM

| Algorithm name | PSNR | SSIM |
|---|---|---|
| DeblurGAN | 27.75 | 0.805 |
| Method of the present disclosure | 27.10 | 0.807 |

From Table 1, it can be seen that the method of the present disclosure is basically on par with DeblurGAN in terms of objective indicators such as PSNR and SSIM, with PSNR slightly lower than DeblurGAN and SSIM slightly higher than DeblurGAN. This is because PSNR only considers the differences between pixels and cannot represent the actual perception of the human eye. SSIM only evaluates the macroscopic perception levels of brightness, contrast, and structure. While the method of the present disclosure mainly improves on two aspects: artifact elimination and detail texture restoration. These two objective evaluation indicators cannot effectively provide an objective quantitative analysis of the quality improvement of the method of the present disclosure in one aspect of motion deblurring.

To better demonstrate the superiority of the method of the present disclosure, the YOLOv5 object detection model is used in the comparative experiment to recognize vehicles and pedestrians in the deblurred images, and evaluate two models through recognition accuracy. Wherein, the images used for object detection experiments still use 100 pairs of blur-clear images from the testing set, including a total of 718 targets for cars and pedestrians that contains overlapping targets and small targets captured from afar. Whether small target objects and edge details can be effectively restored from blur is the key to whether they can be correctly recognized. Table 2 shows the accuracy of target recognition before deblurring, the target recognition after using DeblurGAN, and target recognition after using the method of present disclosure to remove motion blur:

TABLE 2
Comparison of recognition accuracy

| Algorithm name | YOLOv5 recognition accuracy |
|---|---|
| Original blurred image | 31.75% |
| DeblurGAN | 58.63% |
| Method of the present disclosure | 74.23% |

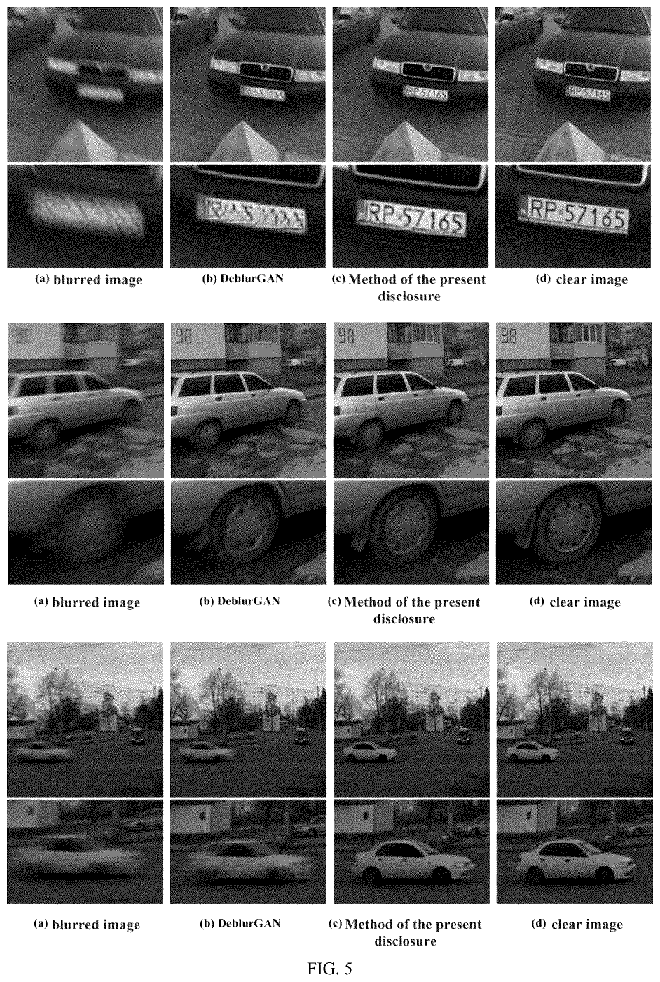

From the experimental data in Table 2 and the comparison of the effect of this method and the DeblurGAN method in processing blurred images shown in FIG. 5, it can be seen that the method of the present disclosure has achieved significant improvement in object detection tasks.

### Embodiment 2

As shown in FIG. 2, the present embodiment of the present disclosure provides an apparatus for image motion deblurring, which can be used to implement the method described in Embodiment 1. The device includes:
An acquisition module, used to obtain a motion-blurred image to be deblurred;
An image motion deblur model, used to input the obtained blurred image into a pre-constructed and pre-trained image motion deblur model based on a multi-scale feature fusion module and a local channel information interaction module, so as to obtain a clear image;
wherein the image motion deblur model is obtained by extracting characteristic information of different spatial scales and frequencies through the multi-scale feature fusion module for feature fusion, and exchanging the fused feature map with local channel information in an one-dimensional convolution manner through the local channel information interaction module, then training the dataset with the objective of minimizing the loss function based on adversarial loss and content loss.

The apparatus for image motion deblurring provided in the present embodiment and the method for image motion deblurring provided in the first embodiment are based on the same technical concept and can produce beneficial effects as described in the first embodiment. The content not described in detail in this embodiment can be found in the first embodiment.

### Embodiment 3

The present embodiment provides an electronic device, including a processor and a storage medium.

The storage medium is used for storing instructions.

The processor is used to perform operations based on instructions to execute the steps of any method according to Embodiment 1.

### Embodiment 4

The present embodiment provides a computer-readable storage medium on which a computer program is stored. When the computer program is executed by a processor, the steps of any method in the first embodiment are implemented.

The skilled person in the art should understand that embodiments of this disclosure may be provided as methods, systems, or computer program products. Therefore, this disclosure may take the form of a complete hardware embodiment, a complete software embodiment, or a combination of software and hardware embodiments. Moreover, this disclosure may take the form of a computer program product implemented on one or more computer available storage media (including but not limited to disk storage, CD-ROM, optical storage, etc.) containing computer available program codes.

This disclosure is described with reference to the flowchart and/or block diagram of the method, device (system), and computer program product according to the embodiments of this disclosure. It should be understood that each process and/or block in the flowchart and/or block diagram can be implemented by computer program instructions, as well as the combination of processes and/or blocks in the flowchart and/or block diagram. These computer program instructions can be provided to processors of general-purpose computers, specialized computers, embedded processors, or other programmable data processing devices to generate a machine, that generates instructions executed by processors of computers or other programmable data processing devices to implement the functions specified in one or more processes and/or blocks in a flowchart.

These computer program instructions can also be stored in computer-readable memory that can guide computers or other programmable data processing devices to work in a specific way, so that the instructions stored in the computer-readable memory generate a manufacturing product including an instruction device that implements the functions specified in one or more processes and/or blocks of a flowchart.

These computer program instructions can also be loaded onto computers or other programmable data processing devices to perform a series of operational steps on the computer or other programmable devices to generate computer-implemented processing, so that the instructions executed on the computer or other programmable devices provide steps for implementing the functions specified in one or more processes and/or blocks in a flowchart.

The above is only a preferred embodiment of the present disclosure. It should be pointed out that for ordinary skilled person in the art, several improvements and modifications can be made without departing from the technical principles of the present disclosure. These improvements and modifications should also be considered as the scope of the present disclosure.

What is claimed is:

1. A method for image motion deblurring, comprising:
obtaining a motion-blurred image to be deblurred;
inputting the obtained blurred image into a pre-constructed and pre-trained image motion deblur model based on a multi-scale feature fusion module and a local channel information interaction module to obtain a clear image;
wherein, the image motion deblur model is obtained through extracting characteristic information of different spatial scales and frequencies through the multi-scale feature fusion module for feature fusion, and exchanging a fused feature map with local channel information in an one-dimensional convolution manner through the local channel information interaction module, and then training a dataset with a objective of minimizing a loss function based on adversarial loss and content loss.

2. The method for image motion deblurring according to claim 1, wherein the constructed image motion deblur model comprises: a convolutional layer for preliminary feature extraction, a plurality of residual blocks with the same structure, and a convolutional layer for image reconstruction; the residual block comprises the multi-scale feature fusion module and the local channel information interaction module; the multi-scale feature fusion module comprises a pyramid convolutional layer and a channel attention mechanism layer; and the local channel information interaction module comprises a global average pooling layer and an one-dimensional convolutional layer.

3. The method for image motion deblurring according to claim 2, wherein the step of extracting characteristic information of different spatial scales and frequencies through the multi-scale feature fusion module for feature fusion comprises:
obtaining an initial feature map X;
conducting feature extraction on the obtained initial feature map X under different spatial scales and frequencies by using multiple types of convolutional kernels in the pyramid convolutional layer to obtain a plurality of sub-feature maps expressed as:
$${F}_{i} = Conv ( {k}_{i} \times {k}_{i} , {G}_{i} ) ( X )$$
in the formula, Fᵢ∈R^{C′×H×W} represents the i-th sub-feature map obtained from the initial feature map X after passing through the i-th type of convolution kernel, i=0, 1, 2, - - - , S−1; S represents the type of convolution kernel; R represents the feature domain, C′, H, and W respectively represent the number of channels, height, and width of the sub-feature maps, Conv represents the convolution operation; kᵢ×kᵢ represents the size of the i-th kernel; Gᵢ represents the calculation parameter for the number of channels in the i-th type of convolutional kernel, expressed as follows:
$${G}_{i} = \{ \begin{matrix}{2}^{\frac{{k}_{i} - 1}{2}} , & {k}_{i} > 3 \\ 1 , & {k}_{i} = 3\end{matrix} ;$$
using the channel attention mechanism layer to obtain channel attention weights of each sub-feature map, and using the Softmax normalization function to calibrate the channel attention weights of each sub-feature map, the expression is:
$${Z}_{i} = SE ( {F}_{i} )$$
$${att}_{i} = Softmax ( {Z}_{i} ) = \frac{exp ( {Z}_{i} )}{{\sum }_{i = 0}^{S - 1} exp ( {Z}_{i} )}$$
in the formula, Zᵢ∈R^{C′×1×1} is the channel attention weight of the i-th sub-feature map, SE represents the channel attention mechanism; attᵢ represents the normalized channel attention weight of the i-th sub feature map;
multiplying each sub-feature map with its corresponding normalized channel attention weight, and concatenating the multiplied feature maps using concatenation operation to obtain the fused feature map, expressed as:
$${Y}_{i} = {F}_{i} ⊙ {att}_{i}$$
$${X}^{′} = Cat ( [ {Y}_{0} , {Y}_{1} , {Y}_{2} , … , {Y}_{S - 1} ] )$$
in the formula, Yᵢ represents the i-th sub-feature map with channel attention weights, ⊙ represents multiplication of channels; X′ represents the fused feature map, and Cat represents concatenation operation.

4. The method for image motion deblurring according to claim 3, wherein the step of exchanging the fused feature map with local channel information in the one-dimensional convolution manner comprises:
obtaining the fused feature map output by the multi-scale feature fusion module;
using the global average pooling layer to perform a global average pooling operation on the fused feature map, the expression is:
$$y = g ( {X}^{′} ) = \frac{1}{WH} {\sum }_{m = 1 , n = 1}^{W , H} {X}_{mn}^{′}$$
in the formula, g(X′) represents the global average pooling of the fused feature map, W, H respectively represents the width and the height of the fused feature map X′, X′ₘₙ represents the pixel values in the m-th row and the n-th column of the fused feature map X′, and y represents the output;
the output y after global average pooled is interacted with the local channel information through the one-dimensional convolutional layer, expressed as:
ω=σ(Conv1Dₖ(y))
in the formula, ω represents the channel attention weight after interaction, Conv1Dₖ represents the one-dimensional convolution kernel, k is the size of the convolution kernel, and σ represents the Sigmod activation function;
multiplying the channel attention weight ω with the fused feature map X′ to assign channel attention to the fused feature map X′ to obtain an information interaction feature map X″.

5. The method for image motion deblurring according to claim 4, wherein the output of the residual block after processing the obtained initial feature map X is the result of adding the initial feature map X and the information interaction feature map X″; the convolutional layer for image reconstruction comprises three convolutional layers, and the output of the residual block after processed by the three convolutional layers is added to the obtained blurred image to obtain the final output clear image.

6. The method for image motion deblurring according to claim 1, wherein the training method of the image motion deblur model comprises:
compressing the collected images in the dataset into images with a resolution of 360×360 and randomly cropping the image to the size of 256×256, then dividing them into a training set and a testing set;
inputting the training set into the constructed image motion deblur model to reconstruct the deblurred image through multi-scale feature fusion and local channel information interaction;
conducting a supervised training on the model according to the testing set using a loss function based on adversarial loss and content loss;
repeating the training process to update the network parameters of the optimized model until the loss function converges or reaches the preset number of training iterations, and stop training to obtain the final optimized image motion deblur model.

7. The method for image motion deblurring according to claim 6, wherein the loss function based on the adversarial loss and the content loss is as follows:
$${ℒ}_{total} = {ℒ}_{adv} + {λℒ}_{content}$$
in the formula, [symbol] ₜₒₜₐₗ represents the loss function, [symbol] _{adv} represents the adversarial loss, [symbol] _{content} represents the content loss, λ is a content loss coefficient; the adversarial loss [symbol] _{adv} is expressed as WGAN-GP as below:
$${ℒ}_{adv} = {𝔼}_{\tilde{x} ∼ {P}_{g}} [ D ( \tilde{x} ) ] - {𝔼}_{x ∼ {P}_{r}} [ D ( x ) ] + λ {𝔼}_{\hat{x} ∼ {P}_{\hat{x}}} [ {( {‖ {∇}_{\hat{x}} D ( \hat{x} ) ‖}_{2} - 1 )}^{2} ]$$
in the formula, D represents discriminator, x represents clear image, \tilde{x} represents network output image, \hat{x} represents random image, \hat{x}=∈\tilde{x}+(1−∈)x, ∈˜U[0,1]; P_{\hat{x}} represents that a distribution of image samples uniformly sampled along a straight line between a pair of points U[0,1] sampled from clear image distribution Pᵣ and network output image distribution P_{g};
the content loss adopts perceptual loss, expressed as:
$${ℒ}_{content} = \sum {‖ ϕ ( x ) - ϕ ( \tilde{x} ) ‖}_{2}^{2}$$
in the formula, ϕ represents the pre-trained VGG19 network.

8. An apparatus for image motion deblurring, comprising:
an acquisition module, used to obtain a motion-blurred image to be deblurred;
an image motion deblur model, used to input the obtained blurred image into a pre-constructed and pre-trained image motion deblur model based on a multi-scale feature fusion module and a local channel information interaction module, so as to obtain a clear image;
wherein, the image motion deblurring model is obtained by extracting characteristic information of different spatial scales and frequencies through a multi-scale feature fusion module for feature fusion, and exchanging a fused feature map with local channel information in an one-dimensional convolution manner through the local channel information interaction module, and then training a dataset with a objective of minimizing a loss function based on adversarial loss and content loss.

9. An electronic device, comprising a processor and a storage medium;
the storage medium is configured to store instructions;
the processor is configured to operate based on the instructions to execute the steps of the method for image motion deblurring according to claim 1.

10. A computer-readable storage medium that stores a computer program, characterized in that when the computer program is executed by a processor, the steps of the method for image motion deblurring as claimed in claim 1 are implemented.
